(19) United States
(12) Patent Application Publication
(10) Pub. No.: US 2018/0043516 A1
(43) Pub. Date: Feb. 15, 2018

(54) SCREWDRIVER

(71) Applicant: CHERVON (HK) LIMITED, Wanchai (HK)

(72) Inventors: Xiaofeng Zhang, Nanjing (CN); Rongzhen Li, Nanjing (CN)

(21) Appl. No.: 15/649,281

(22) Filed: Jul. 13, 2017

(30) Foreign Application Priority Data
Aug. 10, 2016 (CN) 201610653665.1

(51) Int. Cl. B25B 23/12; B25G 1/08; B25B 15/02; B25B 23/00

(52) U.S. Cl. CPC B25B 23/12; B25B 23/0035; B25G 1/085; B25B 15/02

(57) ABSTRACT

A screwdriver includes bits, a handle for a user to grip and a magnetic device with magnetic performance, which can be engaged with the bit to attract a fastener, so that the fastener does not easily fall off when driven by the bit. The handle is formed with a containing recess, and the magnetic device is removably contained in the containing recess.

### RELATED APPLICATION INFORMATION

This application claims the benefit under 35 U.S.C. § 119(a) of Chinese Patent Application No. CN 201610653665.1, filed on Aug. 10, 2016, the disclosure of which is incorporated herein by reference in its entirety.

### FIELD OF THE DISCLOSURE

The present disclosure relates generally to screwdrivers and, more particularly, to a hand screwdriver with a magnetic device.

### BACKGROUND OF THE DISCLOSURE

Screwdrivers are used to drive fasteners, for example bolts.

When a user operates the screwdriver, he usually holds the bolt with one hand and grips the screwdriver with another hand. So, both hands of the user are occupied and the user cannot do other operations with his hand.

The statements in this section merely provide background information related to the present disclosure and may not constitute prior art.

### SUMMARY

In one aspect of the disclosure, a screwdriver is provided. The screwdriver includes bits, a handle for a user to grip and a magnetic device with magnetic performance, which can be engaged with the bit to attract a fastener, so that the fastener does not easily fall off when driven by the bit. The handle is formed with a containing recess, and the magnetic device is removably contained in the containing recess.

Further, the handle further may comprise a fixing element which can be attracted by the magnetic device. When the magnetic device is disposed in the containing recess, the fixing element is attracted by the magnetic device so as to hold the magnetic device in the containing recess.

Further, the magnetic device may comprise a sleeve for setting on the outer surface of the bit and a magnetic element with magnetic performance being fixed to the sleeve.

Further, the magnetic element may be disposed on one end of the sleeve, when the magnetic device is held in the containing recess, the magnetic element is located on the bottom of the containing recess.

Further, the handle may be formed with a drive recess allowing the bit to be detachably inserted therein so as to drive the bit to rotate, the drive recess being disposed on a front end of the handle, and the containing recess being disposed on a rear end of the handle.

Further, the drive recess may have an opening facing the front end of the handle, and the containing recess may have an opening facing the rear end of the handle.

Further, the handle may be formed with several receiving channels for storing the bits where the handle defines a central axis and the receiving channels are extended along a direction of the central axis and arranged circumferentially relative to the central axis.

Further, the handle may comprise a front portion being formed with the receiving channels, a rear portion being formed with the containing recess and a middle portion disposed between the front portion and the rear portion and allowing the bits received in the receiving channels to expose out of the handle.

Further, the handle may comprise a rubber ring for fixing the bits in the receiving channels.

Further, the handle may comprise a first element being formed with the receiving channels and a second element being formed with the containing recess, the second element being detachably connected with the first element.

The present invention has many advantages. The handle is formed with the containing recess for containing the magnetic device. The magnetic device can be contained in the containing recess so as to prevent it from being lost. The drive recess and the containing recess are respectively disposed on the two ends of the handle, so that the size of the screwdriver is reduced.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of an exemplary screwdriver.

FIG. 2 an exploded view of the screwdriver in FIG. 1.

FIG. 3 is a schematic view of a magnetic device in FIG. 1.

FIG. 4 is a schematic view showing the use status of the magnetic device in FIG. 1.

FIG. 5 is a schematic view of a handle in FIG. 1.

FIG. 6 is a section view of the handle in FIG. 1.

FIG. 7 is a schematic view of several receiving channels of the handle in FIG. 6 which receive bits.

FIG. 8 is a schematic view of a containing recess of the handle in FIG. 6 which contains the magnetic device.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the scope of the invention hereinafter claimed, its application, or uses.

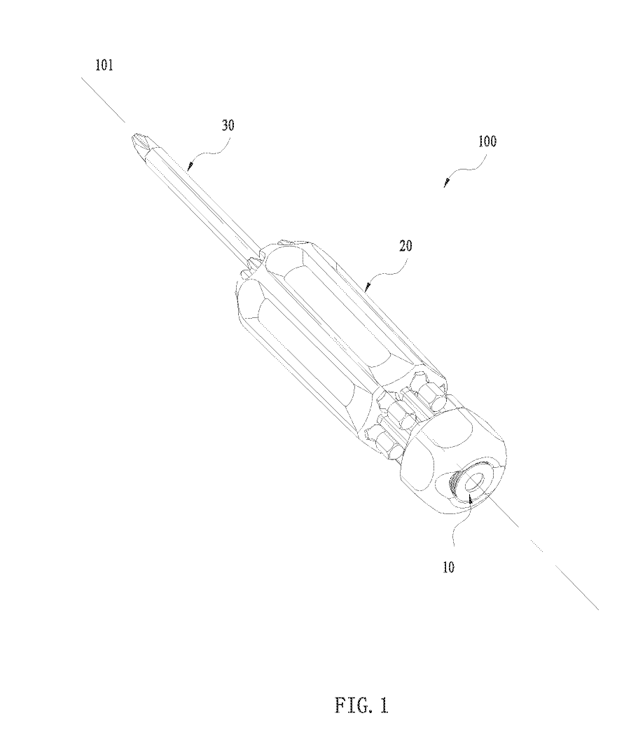

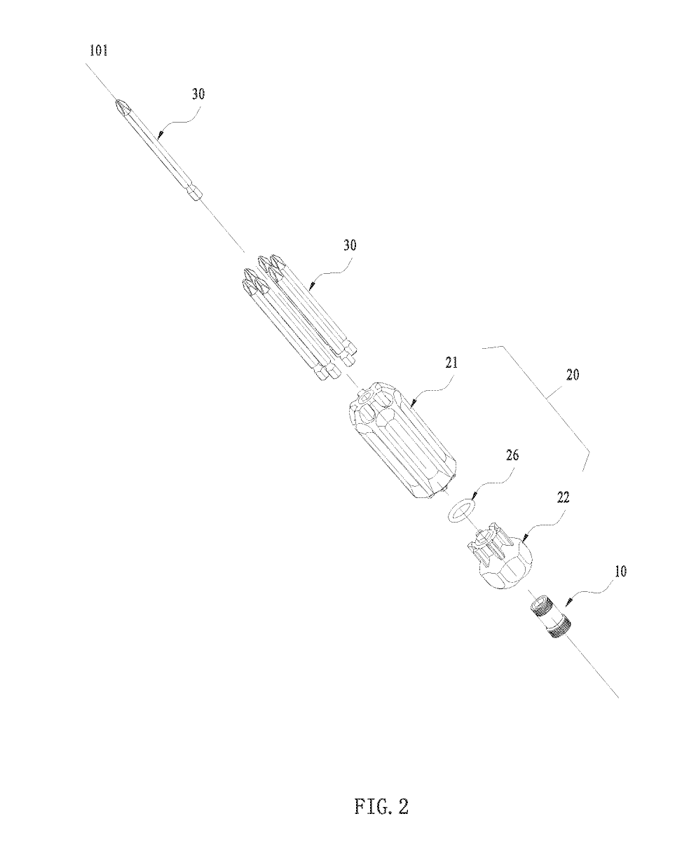

Referring to FIGS. 1-2, a screwdriver 100 includes a magnetic device 10, a handle 20 and bits 30. The handle 20 defines a central axis 101. The handle 20 is capable of engaging with the bit 30. When the handle 20 is rotated about the central axis 101, it can drive the bit 30 to rotate. The screwdriver 100 is a hand screwdriver.

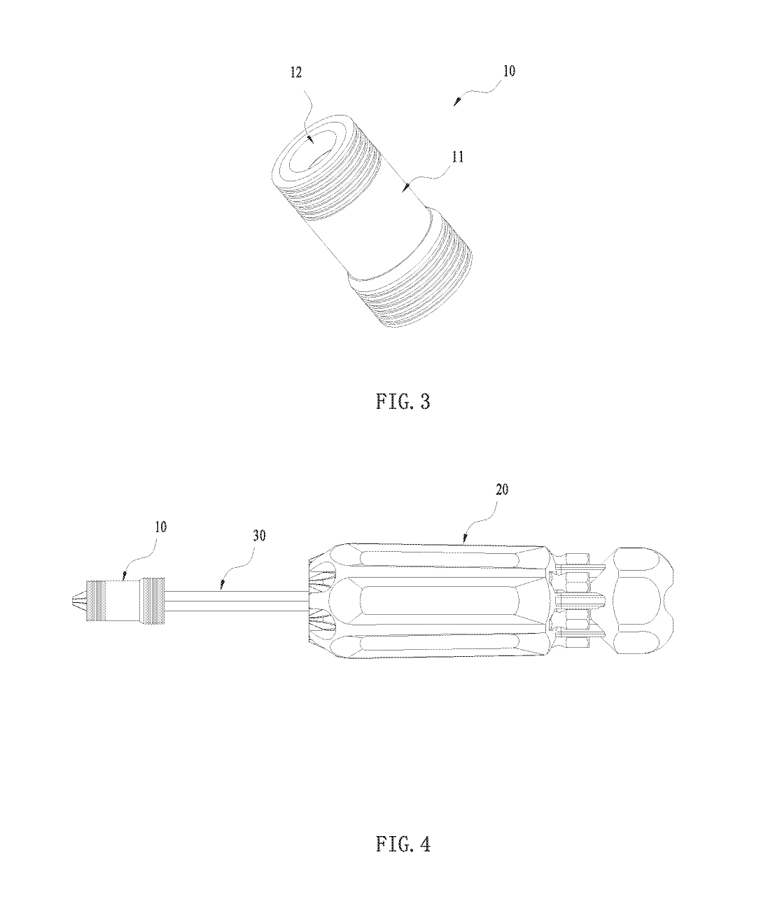

Referring to FIGS. 3-4, the magnetic device 10 includes a sleeve 11 and a magnetic element 12. The sleeve 11 can be set on the outer surface of the bit 30. The magnetic element 12 attracts a fastener, so that the fastener does not easily fall off when driven by the bit 30. The magnetic element 12 is disposed on one end of the sleeve 11. The magnetic device 10 is thus arranged so that a user does not need to hold the fastener, such as a bolt, when he tights the fastener. The magnetic device 10 attracts the bolt and keeps the bolt upright so as to have an effect of holding the bolt.

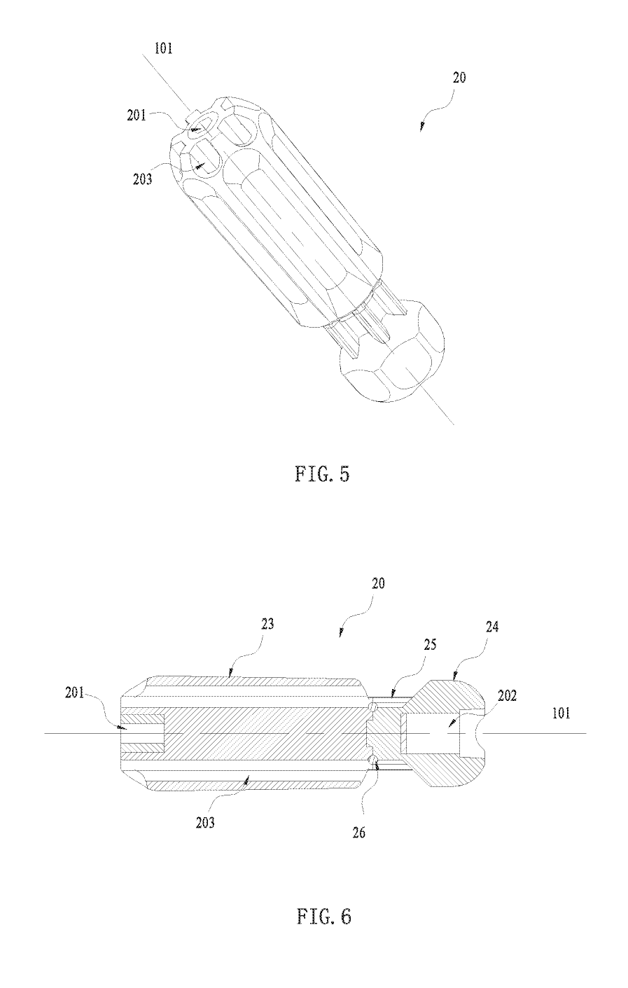

Referring to FIGS. 5-6, the handle 20 is formed with a drive recess 201, a containing recess 202 and several receiving channels 203. The handle 20 has a front end and a rear end along a direction of the central axis 101. The drive recess 201 is located in the front end of the handle 20, and the containing recess 202 is located on the rear end of the handle 20. The drive recess 201 has an opening facing the front end of the handle 20, and the containing recess 202 has an opening facing the rear end of the handle 20. The drive recess 201 is used for the user to insert the chosen bit 30. The user grips and rotates the handle 20 about the central axis 101 so as to drive the bit 30 mounted in the drive recess 201 to rotate about the central axis 101. The containing recess 202 is used to contain the magnetic device 10. When the user does not need to use the magnetic device 10, the magnetic device 10 can be stored in the containing recess 202, which can prevent the magnetic device 10 from being lost. The receiving channels 203 are used to receive the spare bits 30. The receiving channels 203 are extended along the direction of the central axis 101, and arranged circumferentially relative to the central axis 101. When the user operates the handle 20, the spare bits 30 can be stored in the receiving channels 203.

The handle 20 includes a front portion 23, a middle portion 25 and a rear portion 24. The receiving channels 203 are formed in the front portion, and the containing recess 202 is formed in the rear portion 24. The middle portion 25 is disposed between the front portion 23 and the rear portion 24, so that the bits 30 received in the receiving channels 203 are exposed out of the handle 20. The spare bits 30 received in the receiving channels 203 are exposed out of the handle 20 from the middle portion 25 or from one end of the receiving channels 203, which makes the user be able to take out the bit 30 conveniently. The middle portion 25 has a size in a radial direction of the central axis 101 which is less than the size of the front portion 23 or the rear portion 24 in the radial direction. The receiving channels 203 go through the front portion 23 along the direction of the central axis 101. The bits 30 can slide in the receiving channels 203. The containing recess 202 with a step structure has the opening and a bottom, the opening has a size greater than the size of the bottom.

Referring to FIGS. 1-2 and 6-7, the handle 20 includes a first element 21 and a second element 22. The first element 21 is formed with the receiving channels 203, and the second element 22 is formed with the containing recess 202. The handle 20 further includes a rubber ring 26 for fixing the bits 30 in the receiving channels 203. The rubber ring 26 is fixed to the middle portion 25 and disposed between the first element 21 and the second element 22. The second element 22 is detachably connected with the first element 21. The user can separate the first and second elements 21, 22 to take the bit 30 out of the receiving channels 203.

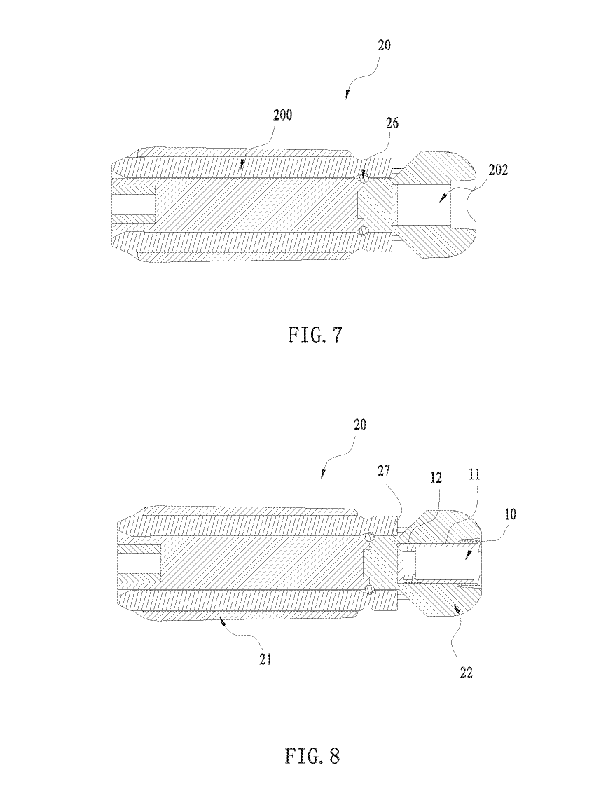

Referring to FIGS. 7-8, when the magnetic device 10 is held in the containing recess 202, the magnetic element 12 is located on the bottom of the containing recess 202. One end of the sleeve 11 having the magnetic element 12 faces the front of the handle 20, and the other end of the sleeve 11 faces the rear of the handle 20.

The handle 20 further includes a fixing element 27 which can be attracted by the magnetic element 12. When the magnetic device 10 is disposed in the containing recess 202, the fixing element 27 is attracted by the magnetic element 12 so as to fix the magnetic device 10.

The fixing element 27 is fixed to the second element 22. The fixing element 27 is made of a metal material, so it also can be called a metal element. Specifically, the fixing element 27 is made of a metal material which can be attracted by the magnetic element 12. As another embodiment, the fixing element 27 is a magnet. The magnet has a magnetic pole which is arranged to be able to attract the magnetic device 10.

The first element 21 is made of a plastic material, and the second element 22 is also made of the plastic material. The first element 21 and the second element 22 are connected together by insertion.

As another embodiment, the fixing element can be used to connect the first element and the second element.

As another embodiment, the second embodiment is made of metal material, and the fixing element can be omitted. The magnetic element attracts the second element directly so as to hold the magnetic device.

The above illustrates and describes basic principles, main features and advantages of the present invention. Those skilled in the art should appreciate that the above embodiments do not limit the invention hereinafter claimed in any form. Technical solutions obtained by equivalent substitution or equivalent variations are all intended to fall within the scope of the claimed invention.

What is claimed is:

1. A screwdriver, comprising:
a bit;
a handle for a user to grip; and
a magnetic device with magnetic performance, which can be engaged with the bit to attract a fastener, so that the fastener does not easily fall off when driven by the bit;
wherein the handle is formed with a containing recess, and the magnetic device is removably contained in the containing recess.

2. The screwdriver of claim 1, wherein the handle further comprises a fixing element which can be attracted by the magnetic device and, when the magnetic device is disposed in the containing recess, the fixing element is attracted by the magnetic device so as to hold the magnetic device in the containing recess.

3. The screwdriver of claim 1, wherein the magnetic device comprises a sleeve for setting on the outer surface of the bit and a magnetic element with magnetic performance being fixed to the sleeve.

4. The screwdriver of claim 3, wherein the magnetic element is disposed on one end of the sleeve and, when the magnetic device is held in the containing recess, the magnetic element is located on the bottom of the containing recess.

5. The screwdriver of claim 1, wherein the handle is formed with a drive recess for allowing the bit to detachably insert therein so as to drive the bit to rotate, the drive recess being disposed on a front end of the handle and the containing recess being disposed on a rear end of the handle.

6. The screwdriver of claim 5, wherein the drive recess has an opening facing the front end of the handle and the containing recess has an opening facing the rear end of the handle.

7. The screwdriver of claim 1, wherein the handle is formed with several receiving channels for storing a plurality of bits, the handle defines a central axis, the receiving channels are extended along a direction of the central axis and arranged circumferentially relative to the central axis.

8. The screwdriver of claim 7, wherein the handle comprises a front portion formed with the receiving channels, a rear portion formed with the containing recess, and a middle portion disposed between the front portion and the rear portion for allowing bits received in the receiving channels to be exposed out of the handle.

9. The screwdriver of claim 8, wherein the handle comprises a rubber ring for fixing bits in the receiving channels.

10. The screwdriver of claim 7, wherein the handle comprises a first element formed with the receiving channels and a second element formed with the containing recess and the second element is detachably connected with the first element.
